(19) United States
(12) Patent Application Publication
(10) Pub. No.: US 2026/0153183 A1
(43) Pub. Date: Jun. 4, 2026

(54) SYSTEMS AND METHODS RELATED TO REINFORCING PADS

(71) Applicant: Yates Vanden Heuvel, Appleton, WI (US)

(72) Inventor: Yates Vanden Heuvel, Appleton, WI (US)

(21) Appl. No.: 18/966,339

(22) Filed: Dec. 3, 2024

(51) Int. Cl. F16L 57/02; B21D 22/02; F16L 41/02

(52) U.S. Cl. CPC F16L 57/02; B21D 22/02; F16L 41/02

(57) ABSTRACT

Systems and methods according to the present invention relate to manufacturing and installing reinforcing pads in piping networks. Reinforcing pads according to the present invention are preferably manufactured using a machine press and a premade die to be installed onto elbow and/or linear pipes. The reinforcing pads may optionally provide for fluid connection between the converging pipes and/or include weep holes to prevent fluid accumulation.

### BACKGROUND OF THE INVENTION

Reinforcing pads, also known as repads, are used to reinforce and/or strengthen high-stress points on pipes and pipe fittings, or to thicken an area on a pipe or fitting to prevent wear on the main pipe or fitting. Such points are often conjunction points, points where two pipes meet and essentially form a T-shape or Y shape, or where a pipe meets a pipe fitting for the purpose of pipe support or to form a nozzle. There are also use cases for repads where the intersecting pipe is only for the purposes of support. In these use cases the repad is serving the purpose of adding strength to the connection weld. There are also use cases for repads where they would be welded to the main pipe or pipe fitting specifically to prevent wear on the main pipe.

No matter the type of connection, the intersection of the two pipes is created and maintained by welding the pipes together. These connections are often used in lieu of a two or three-way pipe fitting piece, both for convenience and cost. Instead of having to order and wait for specialized fitting piece, stub-in and/or stub-on connections are a quick and convenient solution to joining two pipes. However, these connections often experience high levels of stress, which can lead to mechanical failure and/or leaks. Reinforcing pads add strength to the weld point between the two pipes at the base of the stub-in/stub-on.

In creating reinforcing pads, it is often important to choose materials that match the pipes being connected. If the materials differ, it may lead to dissimilar metal corrosion or weak spots. For this reason, reinforcing pads are currently often created from the pipes themselves. For instance, a spare pipe piece is often used to manufacture a reinforcing pad, especially a spare pipe similar to the main pipe for the connection, because it already has a similar or the same thickness and curve (if necessary) of the main pipe. The manufacturing process then requires the spare pipe or pipe fitting to be cut and/or shaped into the reinforcing pad for placement over the main pipe or elbow. However, this process is time consuming in the formation of the pad. Further, it may be exceedingly costly if the required pad is being created from extra pipe or pipe fitting.

Accordingly, improved systems and methods for manufacturing reinforcing pads that are cost effective and efficient are desired.

### SUMMARY OF THE INVENTION

The present invention relates generally to systems and methods related to reinforcing pads. Specifically, the present invention includes systems and methods for manufacturing reinforcing pads.

An embodiment of a method according to the present invention includes the steps of providing a metal piece and pressing the metal piece into a reinforcing pad using a pressing machine. The reinforcing pad includes an outer surface and an inner surface spaced by a pad thickness, a longitudinal curve, and a lateral curve. The lateral curve is greater than the longitudinal curve. The pad thickness is substantially uniform throughout the reinforcing pad.

According to an embodiment of a method according to the present invention, the pressing step further includes the steps of placing a pressing mold in the desired size for the reinforcing pad into the pressing machine and, before the pressing step, placing the metal piece in the mold.

According to another embodiment of a method according to the present invention, the machine press is an electric press.

According to a further embodiment of a method according to the present invention, the machine press is a hydraulic press.

According to yet another embodiment of a method according to the present invention, the method further includes the step of, after the pressing step, trimming excess material from the edges of the reinforcing pad.

According to another embodiment of a method according to the present invention, the method further includes the step of, after the trimming step, forming a weep hole in the reinforcing pad extending from the inner face to the outer face.

According to another embodiment of a method according to the present invention, the method further includes the steps of providing a main pipe and a trunnion to be connected to the main pipe; coupling the reinforcing pad onto the main pipe; and coupling the trunnion with the reinforcing pad.

According to another embodiment of a method according to the present invention, the first coupling step includes the step of welding the reinforcing pad to the main pipe.

According to still another embodiment of a method according to the present invention, the second coupling step includes the step of welding the trunnion to the reinforcing pad.

According to another embodiment of a method according to the present invention, the method further includes the step of, after the trimming step, creating a fluid hole in the reinforcing pad extending from the inner face to the outer faces, the fluid hole having a diameter that is less than the diameter of the trunnion.

According to another embodiment of a method according to the present invention, the method further includes the steps of providing a main pipe and a trunnion to be connected to the main pipe; coupling the reinforcing pad onto the main pipe; and coupling the trunnion with the reinforcing pad. In this embodiment, the trunnion completely encloses the fluid hole of the reinforcing pad.

According to another embodiment of a method according to the present invention, the first coupling step further includes the step of welding the reinforcing pad to the main pipe.

According to another embodiment of a method according to the present invention, the second coupling step further comprising the step of welding the trunnion to the reinforcing pad.

### BRIEF DESCRIPTION OF THE DRAWINGS

FIG. 1 is a perspective view of a reinforcing pad according to the present invention.

FIG. 2 is a left side elevation view of the reinforcing pad of FIG. 1, the right side of which is the same.

FIG. 3 is a front plan view of the reinforcing pad of FIG. 1.

FIG. 4 is a rear plan view of the reinforcing pad of FIG. 1.

FIG. 5 is a top plan view of the reinforcing pad of FIG. 1.

FIG. 6 is a bottom plan view of the reinforcing pad of FIG. 1.

FIG. 7 is a cross-sectional view of the reinforcing pad of FIG. 1, taken along the 7-7 line of FIG. 2.

FIG. 8 is a conceptual view of the process of turning a sheet of metal into a reinforcing pad and installing it at a pipe junction according to the present invention.

FIG. 9 is a left side elevation view of a reinforcing pad installed at a connection point between an elbow pipe and a trunnion.

FIG. 10 is a left side elevation view of a reinforcing pad installed at a connection point between a linear pipe and a trunnion.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention.

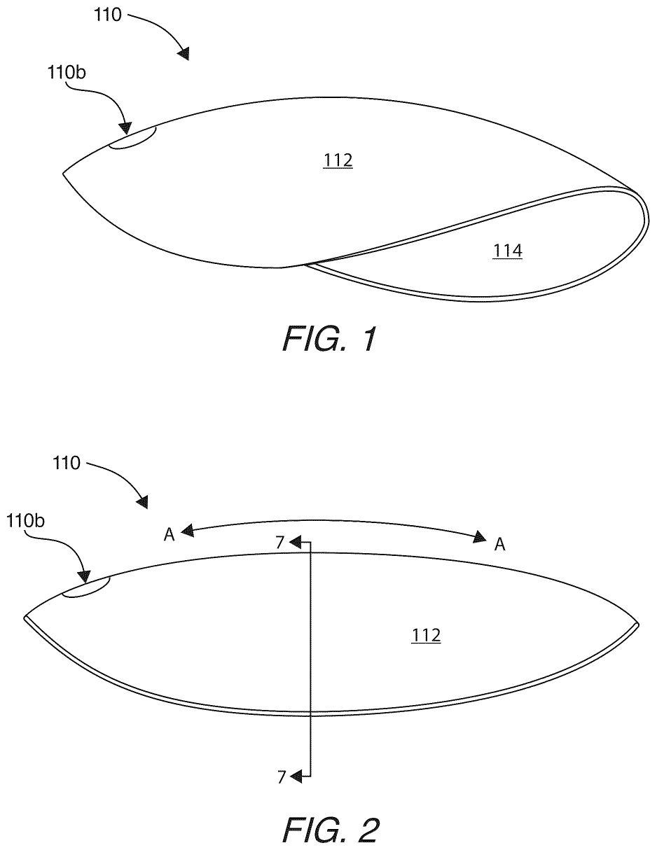

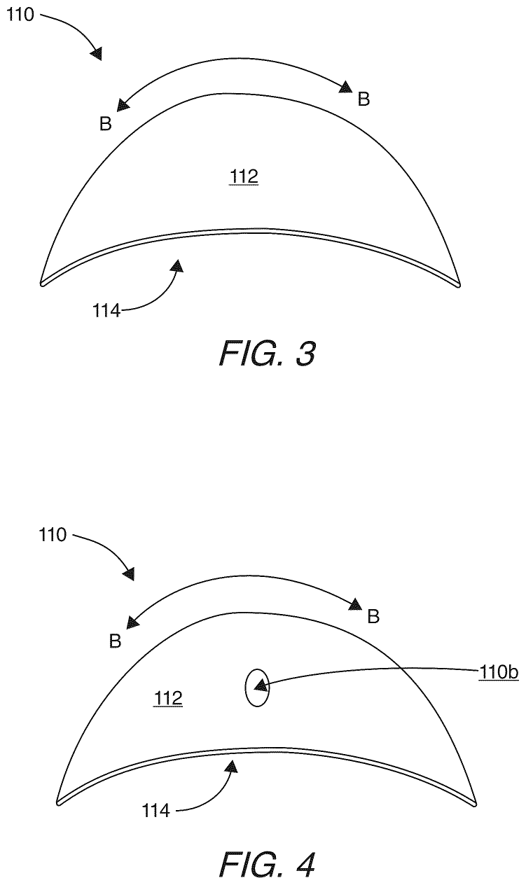

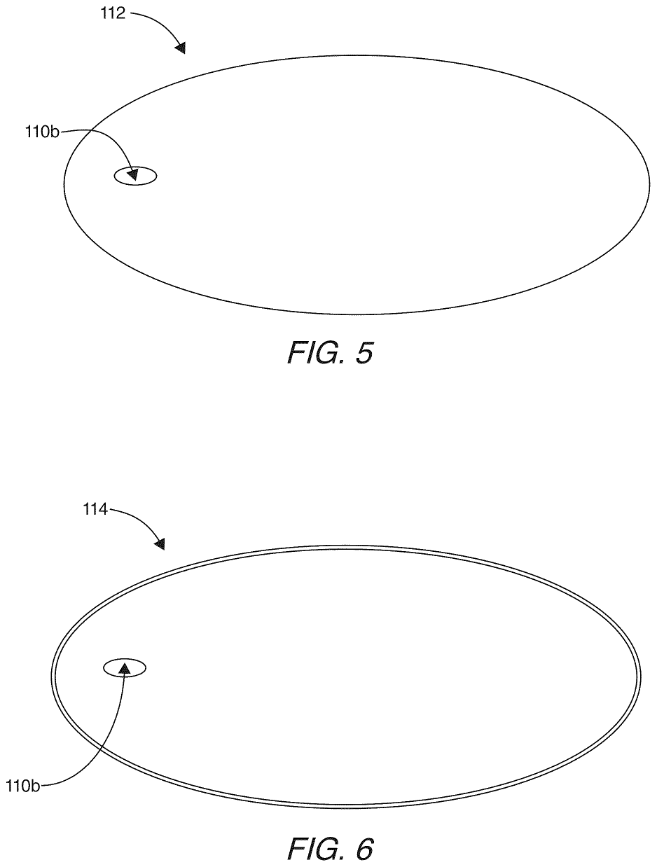

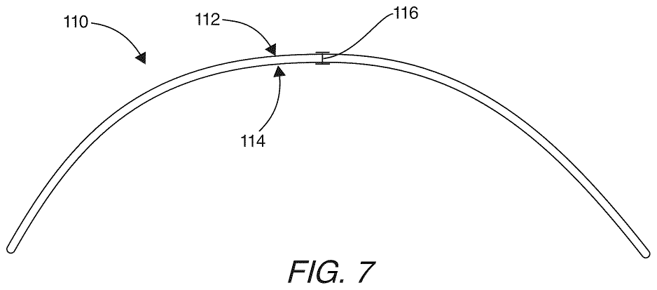

Turning now to the figures, systems and methods relating to reinforcing pads may be described. As seen in FIGS. 1-10, a system 100 for manufacturing reinforcing pads generally includes a machine press 160 used to shape a metal piece 150 into a reinforcing pad 110. A reinforcing pad 110 is generally used to strengthen the connection point between a trunnion 130, or branch pipe, and a main pipe 120. In some embodiments of the present invention, the main pipe 120, trunnion 130, and reinforcing pad 110 may be made of the same or similar material, such as stainless steel. However, other embodiments may feature differing materials, including different types of metals or plastics (e.g. PVC pipes).

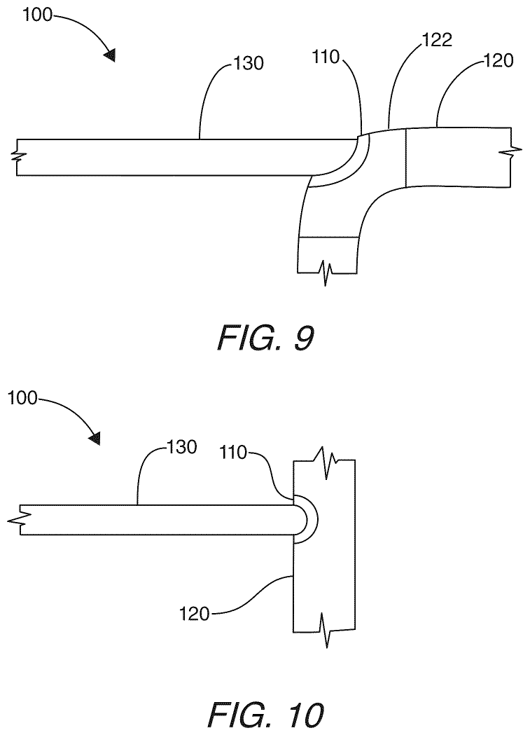

As seen in FIGS. 9 and 10, reinforcing pads 110 are often used at the connection between the trunnion 130 and the main pipe 120. The main pipe 120 may be an elbow pipe, having an elbow 122 following a longitudinal curve C-C and a lateral curve D-D, and the trunnion 130 may be joined at this elbow 122. The reinforcing pad 110, therefore, needs to be substantially similar to the surface of the elbow 122. In the past, this task has been accomplished by creating the reinforcement pads from the elbow pipes themselves, usually involving cutting and/or grinding processes to work the pipe into the pad as needed. However, this process is both exceedingly time consuming and costly, since a new elbow pipe would need to be ordered or at least procured and worked for each pad needed. Therefore, the present invention is advantageous in that many reinforcement pads may be created in rapid succession and the pads may be scaled to the desired pipe size or curve needed.

The reinforcing pad 110 according to the present invention generally comprises an outer face 112 opposing an inner face 114 and spaced by a preferably substantially uniform pad thickness 116. Each pad 110 also preferably comprises one or more dimensions of curvature, such as a longitudinal curve or arc A-A that is the same or at least substantially similar to the longitudinal curve or arc C-C of the elbow 122 and a lateral curve B-B that is the same or at least substantially similar to the lateral curve D-D of the elbow 122. In alternative pipe structures wherein the main pipe 120 is substantially linear and the trunnion 130 is joined at a point along the main pipe 120, as seen in FIG. 10, the reinforcing pad 110 may preferably comprise only a lateral curve B-B matching the lateral curve of the main pipe D-D. The longitudinal curve A-A of the pad 110 in this scenario is preferably substantially zero, i.e. the pad 110 is longitudinally linear to fit with the linear main pipe 120.

In installation, the reinforcing pad 110 is fitted over the main pipe 120 at the desired connection point, where the inner face 114 of the pad 110 is contacting the main pipe 120, and welded in place. The trunnion 130 is placed abutting the outer face 112 of the pad 110 and also welded into place. The order that these two welding processes take place is not particularly important, although it is preferable to weld the pad 110 onto the main pipe 120 first for stability purposes. The welding process can be of any type, including flux-cored arc welding (FCAW), gas metal arc welding (MIG or GMAW), gas tungsten arc welding (TIG or GTAW), or shielded metal arc welding (STICK or SMAW). The welding process chosen may be whatever fits the needs or abilities of the manufacturer at the time of manufacturing and/or installation.

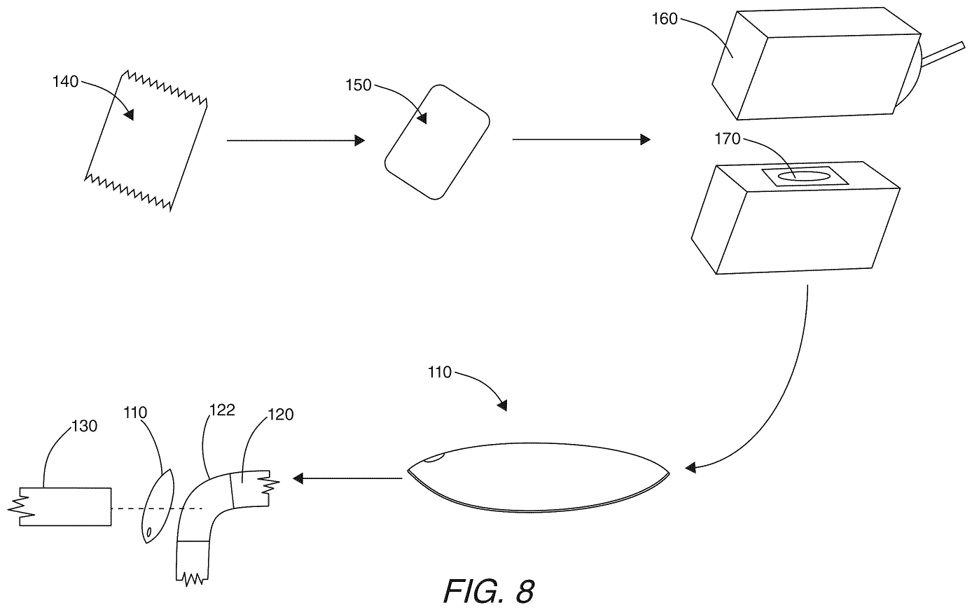

The manufacturing process may be described with reference to FIG. 8. To start, a flat metal sheet 140 of preferably stainless steel is provided. That metal sheet 140 is then preferably cut down to a smaller sized metal piece 150, the size of the piece 150 depending on the eventual size of the reinforcing pad 110 needed. The cutting process may be performed by laser, plasma cutter, or water jet.

Once the metal piece 150 is cut, it is inserted into the machine press 160 and formed into the reinforcing pad 110. The machine press 160 may be a hydraulic or electric press known in the art, such as a Baileigh® HSP-200M-C. However, preferably used in conjunction with the machine press 160 are custom made dies or molds 170. The dies 170 may be created to fit a specific pipe according to a specific need, but more preferably a series of dies 170 are used that conform to the sizes and shapes commonly used in construction. Thus, the manufacturing of reinforcing pads 110 may be streamlined by creating many pads 110 in quick succession according to dies 170 formed in commonly used shapes and sizes. To create a specific sized pad 110, the desired sized die 170 is loaded into the machine press 160, followed by the metal piece 150. The machine press 160 then uses pressure to form the metal piece 150 into the die 170 shape, creating the reinforcing pad 110 in the desired size. The rough reinforcing pad 110 may then be further shaped (i.e. cut, ground, molded, etc.) to obtain the desired shape and create a snug fit with the main pipe 120. For instance, excess material may be excised (shaved, trimmed, ground, etc.) from the edges of the reinforcing pad 110 to create the exact desired shape and/or make a smooth edge surface for welding.

Further steps may be required in creating the reinforcing pads 110 according to installation requirements. For instance, some pipe connections require fluid communication between the main pipe 120 and the trunnion 130. In such instances, the reinforcing pad 110 may preferably include a fluid hole 110a (not pictured). This fluid hole 110a may be cut or stamped in to the pad 110 during manufacturing. Preferably, the fluid hole 110a is substantially circular, having the same or a slightly smaller diameter than the trunnion 130 to provide smooth fluid flow and limit turbulence. Other reinforcing pads 110 may require the addition of a cut or drilled weep hole 110b to help prevent fluid accumulation at the pipe conjunction and/or assist with ventilation and reducing hydrostatic pressure. The reinforcing pads 110 may also be buffed and/or polished for structural integrity or even aesthetic reasons.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention.

I claim:

1. A method comprising the steps of:
providing a metal piece; and
pressing the metal piece into a reinforcing pad using a pressing machine, the reinforcing pad comprising an outer surface and an inner surface spaced by a pad thickness, a longitudinal curve, and a lateral curve,
wherein the lateral curve is greater than the longitudinal curve, and
wherein the pad thickness is substantially uniform throughout the reinforcing pad.

2. The method of claim 1, the pressing step further comprising the steps of:
placing a pressing mold in the desired size for the reinforcing pad into the pressing machine; and
before the pressing step, placing the metal piece in the mold.

3. The method of claim 2, wherein the machine press is an electric press.

4. The method of claim 2, wherein the machine press is a hydraulic press.

5. The method of claim 4, the method further comprising the step of:
after the pressing step, trimming excess material from the edges of the reinforcing pad.

6. The method of claim 5, the method further including the step of:
after the trimming step, forming a weep hole in the reinforcing pad extending from the inner face to the outer face.

7. The method of claim 6, the method further comprising the steps of:
providing a main pipe and a trunnion to be connected to the main pipe;
coupling the reinforcing pad onto the main pipe; and
coupling the trunnion with the reinforcing pad.

8. The method of claim 7, the first coupling step comprising the step of welding the reinforcing pad to the main pipe.

9. The method of claim 8, the second coupling step comprising the step of welding the trunnion to the reinforcing pad.

10. The method of claim 5, the method further including the step of:
after the trimming step, creating a fluid hole in the reinforcing pad extending from the inner face to the outer faces, the fluid hole having a diameter that is less than the diameter of the trunnion.

11. The method of claim 10, the method further comprising the steps of:
providing a main pipe and a trunnion to be connected to the main pipe;
coupling the reinforcing pad onto the main pipe; and
coupling the trunnion with the reinforcing pad, wherein the trunnion completely encloses the fluid hole of the reinforcing pad.

12. The method of claim 11, the first coupling step further comprising the step of welding the reinforcing pad to the main pipe.

13. The method of claim 12, the second coupling step further comprising the step of welding the trunnion to the reinforcing pad.
